(19) United States
(12) Patent Application Publication
(10) Pub. No.: US 2018/0303071 A1
(43) Pub. Date: Oct. 25, 2018

(54) Bone, treat and chew toy holding arrangement for pets

(71) Applicant: Don Halgren, Manchester, MA (US)

(72) Inventor: George Allen, JR., Gloucester, MA (US)

(21) Appl. No.: 15/932,680

(22) Filed: Apr. 6, 2018

Related U.S. Application Data
(60) Provisional application No. 62/601,999, filed on Apr. 7, 2017.

(51) Int. Cl. A01K 29/00; B25B 5/10

(52) U.S. Cl. CPC A01K 29/00; A01K 15/026; B25B 5/102

(57) ABSTRACT

An enclosed gripping arrangement for safely, securely and adjustably supporting a bone, treat or chew toy for a pet, comprising: an elongated enclosure housing defined by a wall, the elongated enclosure housing having a 1^{st} adjustment end and a 2^{nd} base end, the base end having a base arrangement therewith, the elongated enclosure housing enclosing an elongated adjustable first shaft extending through the 1^{st} adjustment end, and an elongated second shaft extending within the 2^{nd} base end from a base thereof. An opposed arrangement of gripping jaws comprising a first gripping jaw on a distal end of the elongated adjustable 1^{st} shaft, and a second gripping jaw arranged on a distal end of the elongated adjustable second shaft, to define a gripping zone therebetween. An opening through the wall of the enclosure housing is longitudinally off-set from the gripping zone of the opposed arrangement of gripping jaws, so as to enable a bone, treat or chew toy to be tightly gripped within the elongated housing and extend through the wall of the housing of the elongated housing to provide a safely contained gripping arrangement to support a chewing treat to a pet.

This application is based upon my U.S. Provisional Application No. 62/601,999, filed 7 Apr. 2017, and is incorporated herein by reference in its entirety.

### BACKGROUND OF THE INVENTION

### Field of the Invention

This invention relates to the pet industry and more particularly to a control arrangement for holding treats, bones and/or toys for pets so they may enjoy those items in a safe and controlled manner.

### Discussion of the Prior Art

The pet industry is worth billions of dollars the year particularly in the United States. Devices for grooming, feeding and entertaining pets are ubiquitous. One such device is shown in US patent application US 2003/0172879. This device shows an elongated arm for squeezably holding a chew toy for a pet. Such device however, exposes a pet to components which may injure that pet. US patent application 2003/0205206 shows a chew toy holder having a threaded shaft extending from a base. The threaded shaft, the top of which supports a chew toy bolted thereto. The threaded shaft ultimately could provide a problem for a pet which is chewing on that chew toy there attached. The release and reattachment of a further chew toy would also be very cumbersome and likely messy. US patent application US 2013/0277526 presents a chew toy being held by a plastic strap against the base. This arrangement similarly exposes the pet to a possibly hazardous strap securement arrangement, which is certainly undesirable. U.S. Pat. No. 9,004,011 discloses a weighted support base onto which a chew toy is secured by a securement strap.

Typical of all these devices is the fact that the pet is exposed to the actual components of the holding apparatus which secures the chew toy. That and other features of these devices makes them less than desirable.

It is an object of the present invention to overcome the disadvantages of the prior art.

It is a further object of the present invention to provide a chew toy holding arrangement which permits the chew toy to be held without being exposed to the animals attempting the biting thereof.

It is a further object of the present invention to provide a device for safely holding an elongated bone or chew toy at a comfortable angle with respect to the horizontal.

It is still a further object of the present invention to provide a chew toy holding arrangement which maximizes the exposure of a chew toy or bone held securely at an incline or angle for the efficient use of the chewable bone and the ability of a pet to grab same.

It is yet a further object of the present invention to provide a chew toy holding arrangement which enables an arrangement of chew toys to be readily changed.

It is yet it still further object of the present invention to provide a chew toy holding arrangement which can be adjusted according to the height of the particular pet enjoying the chew toy.

### BRIEF DESCRIPTION OF THE DRAWINGS

The objects and advantages of the present invention will become more apparent, when viewed in conjunction with the following drawings in which:

FIG. 1 is a perspective view of the chew toy holding arrangement constructed according to the principles of the present invention;

FIG. 2 is a side elevational view, in section, of the chew toy holding arrangement represented in FIG. 1;

FIG. 3 is a side elevational view, in section, of the chew toy holding arrangement represented in FIG. 2 but rotated about its longitudinal vertical axis by 90°;

FIG. 4 is a partial side elevational view in section of the chew toy holding arrangement with a securement adjustment component shown thereon;

FIG. 5 is a partial side elevational view in section of the chew toy holding arrangement with a cover housing arranged a thereon;

FIG. 6 is a side elevational view partially in section of the chew toy holding arrangement indicating a biasing arrangement on one portion of the chew toy holding jaws;

FIG. 7 is a side elevational view in vertical section of a further embodiment of the present invention showing a unitary housing and an off centric holding arrangement there within; and

FIG. 8 is a partial perspective view of a “pillar” type vice represented in FIG. 7, wherein a split lower jaw of that “pillar” type vice has offset gripping surfaces to further enable slanted or angled holding of a bone or chew toy thereby.

### BRIEF SUMMARY OF THE INVENTION

The present invention is a bone, treat or chew toy holding apparatus for pets. The holding apparatus in one embodiment, is preferably comprised of a vertically oriented 1^{st} housing and a vertically oriented 2^{nd} housing join together at a common periphery. The 1^{st} and 2^{nd} housings enclose a gripping arrangement therewithin. The 1^{st} housing encloses a 1^{st} portion of the gripping arrangement and the 2^{nd} housing portion encloses a 2^{nd} portion of the gripping arrangement.

The gripping arrangement comprises a pair of jaws in longitudinal parallel alignment within the longitudinal axis of their respective elongated housings. Each of the pair of jaws is supported on an elongated shaft. The gripping arrangement in the 1^{st} housing portion preferably comprises an elongated threaded shaft which extends through a closed 1^{st} end thereof. The threaded shaft extending through the closed end of the 1^{st} housing portion has an adjustment mechanism thereon to enable longitudinal adjustment of the jaw at the other or distal end of that elongated shaft.

The Jaw in the 2^{nd} housing portion supported on an elongated shaft may be longitudinally adjusted by a telescoping and or bayonet arrangement. The 2^{nd} housing elongated shaft is attached at its proximal end to a base in the 2^{nd} housing portion.

The 2^{nd} housing portion itself in one embodiment, may be longitudinally adjusted to raise or lower its height according to the requirements of the particular pet to which it serves. The longitudinal adjustment mechanism of the 2^{nd} housing portion may be a spiral or threaded arrangement therearound. The 2^{nd} housing portion in one preferred embodiment may be attached to a base plate to eliminate the need for its anchoring against a floor or panel. The 1^{st} housing portion and the 2^{nd} housing portion may be threadedly attached to one another. The 2^{nd} housing portion may have in a further embodiment a supplemental portion which is attachable to the base plate or to a floor or panel. The supplemental portion has a pivot which permits the swiveling of the 2^{nd} housing portion about its longitudinal axis.

The 1^{st} housing portion as an opening through its sidewall at a location which is longitudinally askew (displaced with respect to) to the general location of the gripping zone between the 1^{st} and 2^{nd} the jaws. Each jaw preferably is of V-shape and face one another to form a gripping zone mechanism for gripping a chew toy, a bone or the like safely within the environs of the 1^{st} housing portion. It is anticipated that any bone or chew toy to be gripped between the facing 1^{st} and 2^{nd} jaws will have its own longitudinal axis. A preferred embodiment for gripping such chew toy or bone is arranged when the facing 1^{st} and 2^{nd} jaws enable such chew toy or bone to extend through the opening in the sidewall of the 1^{st} housing portion at an angle of about 10 to 30° with respect to the horizontal (horizon). The 1^{st} housing portion preferably has an enclosure covering the adjustment mechanism arranged at its closed end.

The adjustment mechanism at the closed end of the 1^{st} housing portion may be comprised of a rotatable handle to longitudinally adjust the elongated support or threaded shaft carrying the 1^{st} jaw. The adjustment mechanism at the closed end of the 1^{st} housing portion may in a further embodiment, be comprised of a biasable cam and lever to control the separation and gripping capabilities between the 1^{st} and 2^{nd} jaws.

In yet a further embodiment of the present invention, the elongated housings may be attached to a vertical wall or vertical panel or the like wherein the 2^{nd} jaw may be longitudinally adjustable by an adjustment mechanism arranged on the outer side of the 2^{nd} housing portion.

A yet further embodiment of the present invention comprises an elongated single or unitary housing, preferably round or circular in cross-section, which housing is attached to a base member. The housing has an opening in a sidewall thereof, as in an earlier embodiment, for non-aligned gripped-receipt of a chew toy or bone. A bone or toy gripping apparatus is arranged within the housing. The gripping apparatus may for example, comprises a “pillar” type vice generally similar to that discussed hereinabove. More particularly, the “pillar” type vice has a displaceable 1^{st} or upper jaw blade with an inverted “V” shape jaw which adjustably and tightenably slides between a pair of opposed “V”-shaped split lower jaw portions. An inward side of the pair of lower jaw portion is not as long as it's adjacent portion of the lower jaw, so that the two “V” shaped gripping surfaces of the lower jaw portions are not in transverse alignment with one another. This further enables the chew toy or bone to be held at the inclined angle or slant described hereinabove, in addition to the slightly longitudinally displaced opening through the sidewall of the housing.

A yet further preferred embodiment of the present invention includes the chew toy as possibly a stuffed toy animal of the like, having a grip shaft replaceable he attached thereto. The toy's grip shaft would have a distal end which would be gripped within the jaws as for example, the jaws of a “pillar” type vice.

One preferred embodiment of the present invention thus comprises an enclosed gripping arrangement for safely, securely and adjustably supporting a bone, treat or chew toy for a pet, comprising: an elongated 1^{st} housing portion and an elongated 2^{nd} housing portion detachably connected to one another, the 1^{st} housing portion having a cover end, the 2^{nd} housing portion having a base attachment arrangement therewith; an elongated adjustable shaft extending through the 1^{st} housing portion from the cover end, and an elongated shaft extending through the 2^{nd} housing portion from a base therein; an opposed arrangement of gripping jaws comprising a gripping jaw on a distal end of each elongated shaft, and an opening through a wall of the 1^{st} housing portion slightly off-set transversely adjacent the opposed arrangement of gripping jaws, so as to enable a bone, treat or chew toy to extend through the housing wall of the elongated 1^{st} housing to provide a chewing treat to a pet thereby at an angle with respect to the horizontal.

The invention thus comprises an enclosed gripping arrangement for safely, securely and adjustably supporting a bone, treat or chew toy for a pet, comprising: an elongated enclosure housing defined by a wall, the elongated enclosure housing having a 1^{st} adjustment end and a 2^{nd} base end, the base end having a base arrangement therewith, the elongated enclosure housing enclosing an elongated adjustable first shaft extending through the 1^{st} adjustment end, and an elongated second shaft extending within the 2^{nd} base end from a base thereof; an opposed arrangement of gripping jaws comprising a first gripping jaw on a distal end of the elongated adjustable 1^{st} shaft, and a second gripping jaw arranged on a distal end of the elongated adjustable second shaft, the first gripping jaw and the second gripping jaw defining a gripping zone therebetween; and an opening through the wall of the enclosure housing longitudinally off-set from the gripping zone of the opposed arrangement of gripping jaws, so as to enable a bone, treat or chew toy to be tightly gripped within the elongated housing and extend through the wall of the housing of the elongated housing portion at an adjustable angle “A” with respect to the horizontal, if desired, to provide a safely contained gripping arrangement to support a chewing treat to a pet. The elongated adjustable shaft extending through the 1^{st} adjustment end is threadably adjustable therethrough and extends into the elongated enclosure housing. The second elongated shaft is securely attached to the base end of the elongated enclosure housing. The second elongated shaft extending within the base end of the elongated enclosure housing may be longitudinally adjustable. The elongated adjustable shaft extending through the adjustment end may comprise a pair of coextensive commonly-turned screw shafts to enable fast adjustment and clamping of a bone or chew toy in the gripping zone between the jaw arrangement supported by the elongated first and second elongated shafts. The first gripping jaw and the second gripping jaw are preferably “V” shaped in cross-section. The second gripping jaw preferably has a pair of parallel gripping surfaces. The chewing toy may include an attachable holding shaft for its receipt within the gripping zone. At least one of the elongated adjustable shafts is movably displaceable by a biased cam arrangement attached to the elongated enclosure housing. The base end of the elongated enclosure housing portion may be attachable to a vertical wall. The pair of parallel gripping surfaces of the second gripping jaw are preferably spaced apart from one another.

The invention also includes an enclosed gripping arrangement for safely, securely and adjustably gripping and supporting a bone or chew toy for a pet, the enclosed gripping arrangement comprising: a single, elongated generally cylindrically shaped housing assembly having an central longitudinal axis, the housing defined by a wall having a 1^{st} end and a 2^{nd} end wherein the 2^{nd} end includes an occlusive base, and wherein the wall has a bone or chew toy receiving opening therethrough on a side portion thereof. The housing encloses an elongated, adjustable gripping arrangement comprising a 1^{st} and a 2^{nd} adjustably opposed jaw defining a “gripping zone” therebetween, the elongated adjustable gripping arrangement having a longitudinal axis which is spaced between the longitudinal axis of the elongated housing and the wall of the housing adjacent the opening therethrough, wherein the 2^{nd} pair of the jaws of the elongated adjustable gripping arrangement being supported at the base of the housing assembly, the 1^{st} pair of the jaws of the elongated adjustable gripping arrangement extending through the 1^{st} end of the housing assembly wherein the gripping zone of between the 1^{st} and 2^{nd} jaws is longitudinally displaced from the bone or chew toy receiving opening and is spacedly arranged so as to supportively grip a bone or chew toy only at a supported angle “A” through the bone or chew toy receiving opening in the sidewall of the housing assembly.

The gripping assembly has a longitudinal axis and the housing assembly has a longitudinal axis, which longitudinal axes are parallel and spaced apart from one another within the housing assembly. The chew toy itself may have a replaceable grip shaft attached thereto for changing toys therefrom and its receipt within the jaws of the gripping arrangement.

The 2^{nd} jaw has a pair of “V” shaped gripping surfaces which are out of transverse alignment with one another to further enable angled gripping of a chew toy or bone therebetween. The supported angle “A” is preferably between about 10 to about 30 degrees. The elongated housing is at least partially filled with a resin so as to anchor the adjustable gripping arrangement therewithin. The occlusive base on the second end of the housing may preferably extend beyond the cylindrically shaped housing. The occlusive base may include an attachment ring for enabling attachment of the housing to a floor.

### DETAILED DESCRIPTION OF THE PRESENT INVENTION

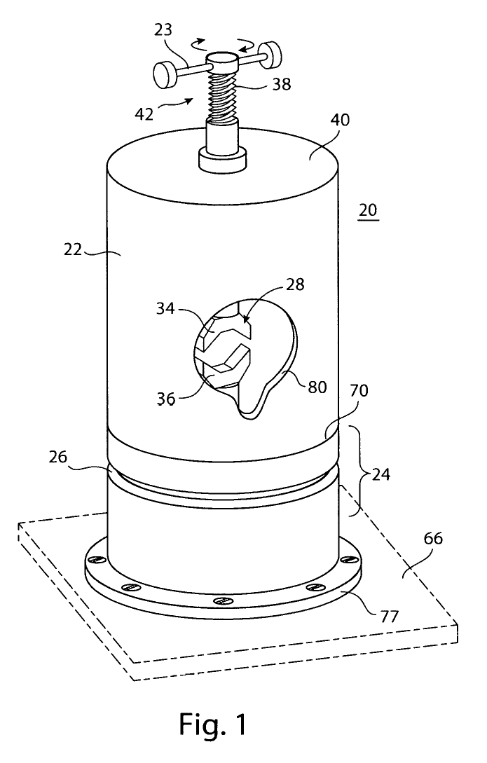

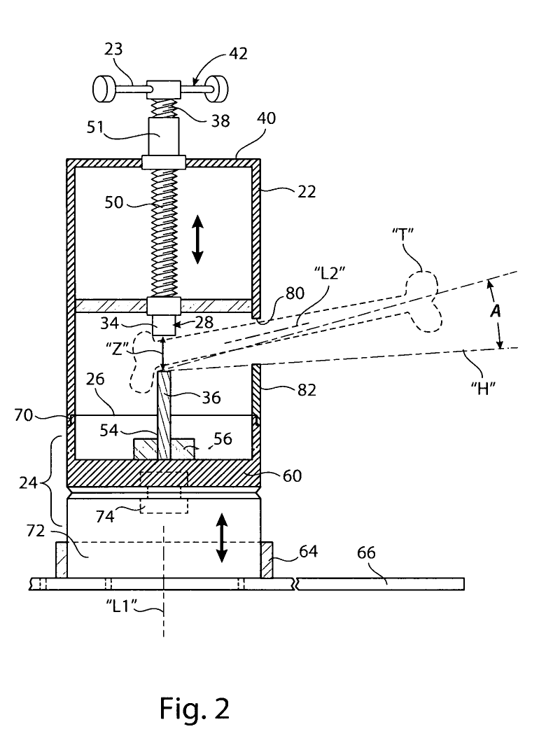

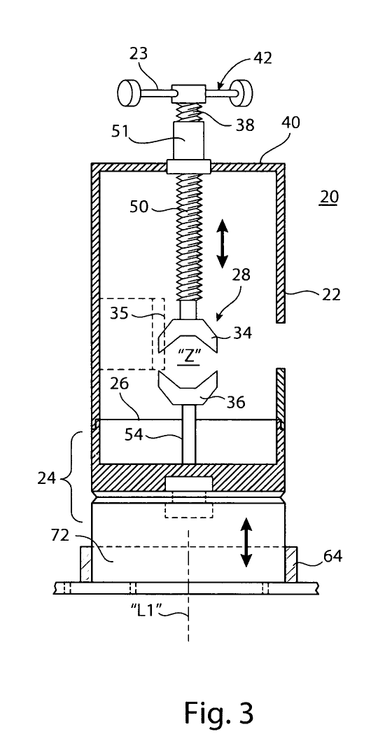

Referring now to the drawings in detail, and particularly to FIG. 1, there is shown a bone, treat or chew toy holding apparatus 20 for pets, for example, dogs. The holding apparatus 20 in one embodiment, is preferably comprised of a vertically oriented 1^{st} housing portion 22 and a vertically oriented 2^{nd} housing portion 24 joined together at a common periphery 26. The housing portions shown are circular although for certain embodiments, they could be of other shapes in cross-section. The 1^{st} and 2^{nd} housing portions 22 and 24 enclose a gripping arrangement 28 therewithin, shown more fully in FIGS. 2, 3, 4 and 5. The 1^{st} housing portion 22 encloses a 1^{st} portion 30 of the gripping arrangement 28 and the 2^{nd} housing portion encloses a 2^{nd} portion 32 of the gripping arrangement 28, best shown in FIGS. 2 and 3, defining a gripping zone “Z” therebetween, which zone “Z” is displaced and out of longitudinal alignment with the bone or chew toy opening 80, as best represented in FIGS. 2, 7 and 8.

The gripping arrangement 28 comprises a pair of jaws 34 and 36 in longitudinal alignment, in this embodiment, within their respective housing portions 22 and 24. Each of the jaws 34 and 36 are preferably of “V” shape in cross-section, as may be seen in FIGS. 1, 3, 4 and 6. Each of the pair of jaws 34 and 36 is supported on an elongated shaft 50 and 54 respectively. The “V” shaped jaw 34 as shown in FIG. 3 may have an elongated jaw guide rail 35 extending longitudinally therealong to ensure that the jaw 34 in the 1^{st} housing portion maintains its proper planar alignment with the jaw 36 in the 2^{nd} housing. A 1^{st} Jaw guide plate 37 may be arranged transversely across the inside of the 1^{st} housing portion. The jaw guide plate 37 would have a central opening therethrough to maintain longitudinal alignment of the 1^{st} elongated shaft 50 and the 2^{nd} elongated shaft 54.

The gripping arrangement in the 1^{st} housing portion 22 preferably comprises an elongated threaded shaft 38 which extends through a closed end 40 thereof. The threaded shaft 38 extending through the closed end 40 of the 1^{st} housing portion 22 has an adjustment mechanism 42 thereon to enable longitudinal adjustment of the jaw 34 at the other or distal end of that elongated shaft 38.

The Jaw 36 in the 2^{nd} housing portion 24 supported on an elongated shaft 54 may be longitudinally adjusted by a telescoping and or bayonet arrangement 56. The 2^{nd} housing portion 24 elongated shaft 54 is attached at its proximal end to a base 60 in the 2^{nd} housing 24 portion.

The 2^{nd} housing portion 24 itself may in one embodiment, be longitudinally adjusted to raise or lower its height according to the requirements of the particular pet to which it serves. A longitudinal adjustment mechanism 64 of the 2^{nd} housing portion 24 may be a spiral or threaded arrangement therearound, as shown in FIG. 2. The 2^{nd} housing portion 24 in one preferred embodiment may be attached to a base plate 66 by an attachment ring 77, shown in FIG. 1, to eliminate the need for its anchoring against a floor or panel. The 1^{st} housing 22 and the 2^{nd} housing portion 24 may be threadedly attached to one another by intermating threads 70 at their juncture 26, as shown in FIG. 2. The 2^{nd} housing portion 24 may have in a further embodiment a supplemental portion 72 which is attachable to the base plate 66 or to a floor or panel, not shown. The supplemental portion 72 may have a pivot 74 which permits the swiveling of the 2^{nd} housing portion 24 about its longitudinal axis “L1”, represented in FIG. 2.

The 1^{st} housing portion 22 as an opening 80 through its sidewall 82 at a location which corresponds angled acutely displaced from the general location of the 1^{st} and 2^{nd} the jaws 34 and 36, as may be seen in FIG. 2, thus further enabling the angled holding of a bone or chew toy “T” therethrough. The opening 80 is preferably of elongated and or tapered shape as represented in FIG. 1 to enable a bone or chew toy ‘T″ to rest in a lower portion thereof thus permitting such chew toy or bone “T” to accommodate different diameters. Each jaw 34 and 36 preferably is of V-shape and face one another to form a gripping zone “Z” gripping mechanism for gripping a chew toy, a bone “T” or the like safely within the environs of the 1^{st} housing portion 22. It is anticipated that any bone or chew toy “T” to be gripped between the facing 1^{st} and 2^{nd} jaws 34 and 36 will be elongated and/or with an attachment shaft and have its own longitudinal axis “L2”, as represented in FIG. 2.

A preferred embodiment for gripping such chew toy or bone “T” is arranged when the facing 1^{st} and 2^{nd} jaws 34 and 36 enable such chew toy or bone “T” to extend through the opening 80 in the sidewall 82 of the 1^{st} housing 22 at an angle “A” of about 0 to about 30 degrees, preferably 15 to 30 degrees with respect to the horizontal “H”, as shown in FIG. 2. The 1^{st} housing portion preferably 22 has an enclosure or cap 86 covering the adjustment mechanism 42 arranged at its closed end 40, as represented in FIG. 5.

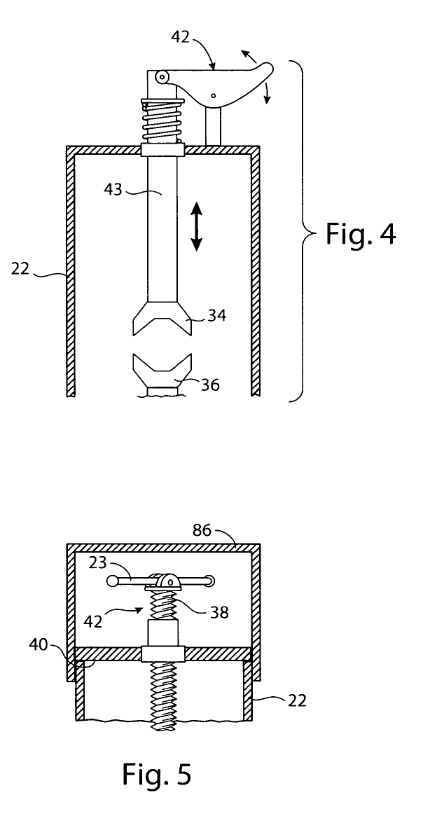

The adjustment mechanism 42 at the closed end of the 1^{st} housing portion 22 may be comprised of a rotatable handle 23 to longitudinally adjust the elongated support or threaded shaft 50 carrying the 1^{st} jaw 34. The threaded shaft 50 may in one embodiment have an inner, counter-threaded shaft 51 to permit faster longitudinal adjustment of the first jaw 34 per common turn of the handle 23, as the adjustment mechanism 42 is turned. The adjustment mechanism 42 at the closed end 40 of the 1^{st} housing portion 22 may in a yet further embodiment, also be comprised of a biasable cam 88 to control the longitudinal displacement of shaft 43 and the separation and gripping capabilities with respect to and between the 1^{st} and 2^{nd} jaws 34 and 36, as represented in FIG. 4.

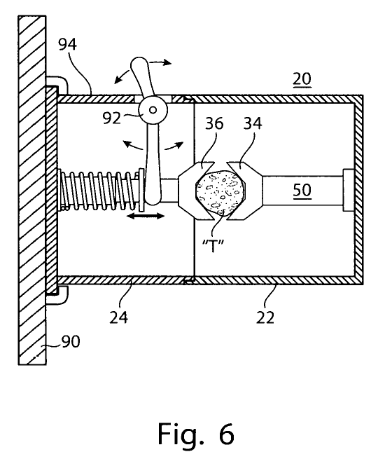

In yet a further embodiment of the present invention, the elongated housings may be attached to a vertical wall or vertical panel 90, or the like, as represented in FIG. 6, wherein the 2^{nd} jaw 36 may be longitudinally adjustable by an adjustment mechanism 92 arranged on the outer side 94 of the 2^{nd} housing 24.

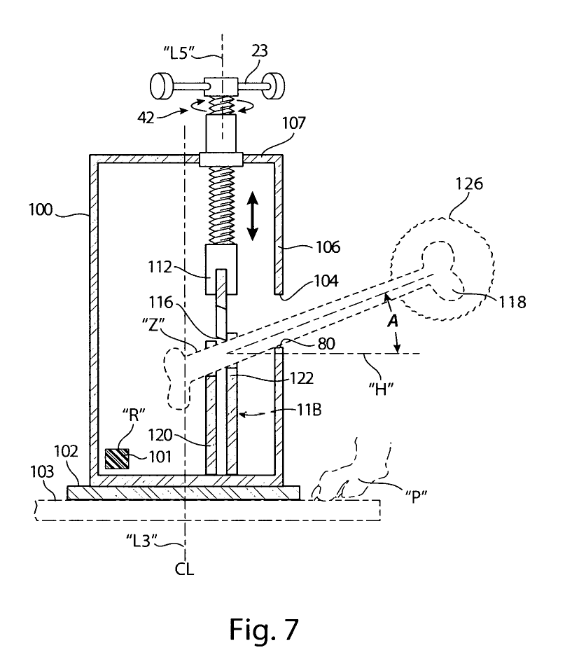

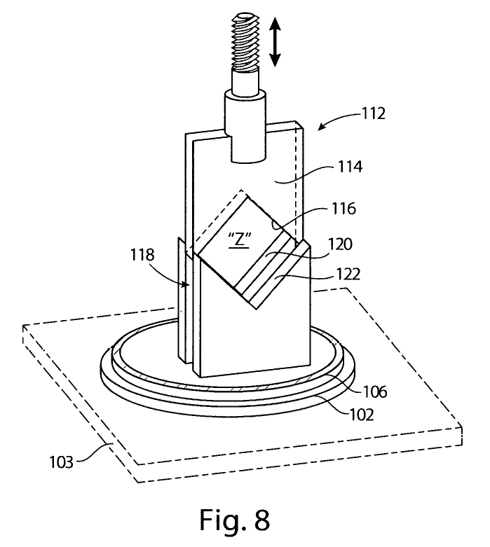

A yet further embodiment of the present invention is shown in FIGS. 7 and 8, the invention comprising an elongated single or unitary (non-sectioned) housing 100, preferably round or circular in cross-section, which housing 100, for stability purposes is preferably about 4″ in inside diameter, is attached to a stability enhancing flange-like base member 102. The base member 102 may be attached to a larger sized base 103 (or floor) to enable a pet “P” (i.e. dog) to step on thus maintaining the housing 100 in place, as partially represented in FIG. 7. The housing 100 has an opening 104 in a sidewall 106 thereof, as in an earlier embodiment, for non-aligned (and inclined at an angle “A”) gripped-receipt of a chew toy or bone 110. A bone or toy gripping apparatus 112 is arranged within the housing 100, through a plate 107 at the closed end 40. The gripping apparatus 112 may for example, comprises for example, a “pillar” type vice generally similar to that discussed hereinabove. The gripping apparatus 112 has a longitudinal axis L5 which is not in alignment with the longitudinal axis L3 of the housing 100. The gripping apparatus 112 is intentionally spaced close to the sidewall 106, as shown in FIG. 7, to enable a pet to have access to as much of an extended bone or chew toy 110 as possible beyond the opening 104 as possible. The housing 100 may be at least partially filled with a weighted or solidifiable material 101 such as for example, a heavy plastic resin “R”, to help anchor the gripping apparatus 112 therein and or to stabilize the housing 100 against excessive movement by a pet.

More particularly, the exemplary “pillar” type vice 112, shown more clearly in partial representation in FIG. 8, has a displaceable 1^{st} or upper single jaw blade 114 with an inverted “V” shape grip 116 which adjustably and tightenably slides between a pair of opposed “V”-shaped split lower jaw portions 118 having split jaw portions 120 and 122. An inwardly placed side 120 of the pair of lower jaw anchor portion 118 is not as long as it's adjacent portion of the lower jaw 122, so that the “V” shaped gripping surfaces of the lower jaw portions 120 and 122 are not in transverse alignment with one another, as may be seen in the edge view represented in FIG. 7. This permits the chew toy or bone 110 to be securely held at the horizontal or at an inclined acute angle “A” or slant with respect to the horizontal, as described hereinabove, in addition being held through the slightly non-horizontally aligned/displaced opening 104 through the sidewall 106 of the housing 100, as represented in FIG. 7.

A yet further preferred embodiment of the present invention includes the chew toy as possibly a stuffed toy animal 126 (represented in phantom in FIG. 7) or the like, having a grip shaft permanently or replaceably attached thereto. The grip shaft 118 would have a distal end which would be gripped within the jaws 116 and 118, as for example the jaws of the “pillar” type vice 112.

I claim:

1. An enclosed gripping arrangement for safely, securely and adjustably supporting a bone, treat or chew toy for a pet, comprising:
an elongated enclosure housing defined by a wall, the elongated enclosure housing having a 1^{st} adjustment end and a 2^{nd} base end, the base end having a base arrangement therewith, the elongated enclosure housing enclosing an elongated adjustable first shaft extending through the 1^{st} adjustment end, and an elongated second shaft extending within the 2^{nd} base end from a base thereof;
an opposed arrangement of gripping jaws comprising a first gripping jaw on a distal end of the elongated adjustable first shaft, and a second gripping jaw arranged on a distal end of the elongated adjustable second shaft, the first gripping jaw and the second gripping jaw defining a gripping zone therebetween; and
an opening through the wall of the elongated enclosure housing longitudinally off-set from the gripping zone of the opposed arrangement of gripping jaws within the elongated enclosure housing, so as to enable a bone, treat or chew toy to be tightly and safely gripped within the elongated housing and having an extended portion thereof extend through the opening in the wall of the elongated enclosure housing at an adjustable angle “A” with respect to the horizontal to provide a safely contained gripping arrangement to support and present a chewing treat to a pet.

2. The enclosed gripping arrangement as recited in claim 1, wherein the elongated adjustable shaft extending through the 1^{st} adjustment end is threadably adjustable therethrough and extends into the elongated enclosure housing.

3. The enclosed gripping arrangement as recited in claim 1 wherein the second elongated shaft is securely attached to the base end of the elongated enclosure housing.

4. The enclosed gripping arrangement as recited in claim 3, wherein the second elongated shaft extending within the base end of the elongated enclosure housing is longitudinally adjustable.

5. The enclosed gripping arrangement as recited in claim 2, wherein the elongated adjustable shaft extending through adjustment end comprises a pair of coextensive commonly-turned screw shafts to enable fast adjustment and clamping of a bone or chew toy in the gripping zone between the jaw arrangement supported by the elongated first and second elongated shafts.

6. The enclosed gripping arrangement as recited in claim 1, wherein the first gripping jaw and the second gripping jaw are “V” shaped in cross-section.

7. The enclosed gripping arrangement as recited in claim 6, wherein the second gripping jaw has a pair of parallel gripping surfaces.

8. The enclosed gripping arrangement as recited in claim 1, wherein the chewing toy may include an attachable holding shaft for receipt within the gripping zone.

9. The enclosed gripping arrangement as recited in claim 1, wherein at least one of the elongated adjustable shafts is movably displaceable by a biased cam arrangement attached to the elongated enclosure housing.

10. The enclosed gripping arrangement as recited in claim 1, wherein the base end of the elongated enclosure housing is attachable to a vertical wall.

11. The enclosed gripping arrangement as recited in claim 7, wherein the pair of parallel gripping surfaces of the second gripping jaw are spaced apart from one another.

12. An enclosed gripping arrangement for safely, securely and adjustably gripping and supporting a bone or chew toy for a pet, the enclosed gripping arrangement comprising:
an elongated housing assembly having a central longitudinal axis, the housing assembly defined by a housing wall having a 1^{st} end and a 2^{nd} end, wherein the 2^{nd} end includes an occlusive base supported on a horizontal, and wherein the housing wall has a bone or chew toy receiving-opening therethrough, the housing assembly enclosing an elongated, adjustable gripping arrangement comprising a 1^{st} and a 2^{nd} adjustably opposed jaw defining a gripping zone therebetween, the elongated adjustable gripping arrangement having a longitudinal axis which is spaced parallel to and between the longitudinal axis of the elongated housing and the housing wall adjacent the opening therethrough, wherein the 2^{nd} jaw of the elongated, adjustable gripping arrangement is supported at the 2^{nd} or base end of the housing assembly, the 1^{st} pair of jaws of the elongated adjustable gripping arrangement extending through the 1^{st} end of the housing assembly, and wherein the gripping zone between the 1^{st} and 2^{nd} jaws of the elongated, adjustable gripping arrangement is longitudinally displaced from the bone or chew toy receiving opening and is spacedly arranged so as to safely supportively grip a bone or chew toy at a supported angle “A” through the bone or chew toy receiving opening in the housing wall of the housing assembly.

13. The enclosed gripping arrangement for safely, securely and adjustably gripping and supporting a bone or chew toy for a pet, as recited in claim 12, wherein the gripping assembly has a longitudinal axis and the housing assembly has a longitudinal axis, which longitudinal axes are parallel and spaced apart from one another within the housing assembly.

14. The enclosed gripping arrangement for safely, securely and adjustably gripping and supporting a bone or chew toy for a pet, as recited in claim 13, wherein the chew toy has a replaceable grip shaft attached thereto for receipt within the jaws of the elongated, adjustable gripping arrangement.

15. The enclosed gripping arrangement for safely, securely and adjustably gripping and supporting a bone or chew toy for a pet, as recited in claim 13, wherein the 2^{nd} jaw of the adjustable, elongated gripping assembly has a pair of “V” shaped gripping surfaces which are out of transverse alignment with one another to further enable angled gripping of a chew toy or bone between the 1^{st} and 2^{nd} jaws of the elongated, adjustable gripping assembly, with respect to the horizontal.

16. The enclosed gripping arrangement as recited in claim 15, wherein the supported angle “A” is between 0 and 30 degrees with respect to the horizontal.

17. The enclosed gripping arrangement as recited in claim 13, wherein the elongated housing assembly is at least partially filled with a hardenable resin so as to solidify about portions of and anchor the adjustable gripping arrangement therewithin.

18. The enclosed gripping arrangement as recited in claim 13, wherein the occlusive base on the second end of the housing extends beyond the wall of the enclosure housing.

19. The enclosed gripping arrangement as recited in claim 18, wherein the occlusive base includes an attachment ring for enabling attachment of the housing assembly to a floor.

20. The enclosure gripping arrangement as recited in claim 18, wherein the elongated enclosure housing is of cylindrical shape to provide balance thereto.
